(19) United States
(12) Patent Application Publication
(10) Pub. No.: US 2014/0204217 A1
(43) Pub. Date: Jul. 24, 2014

(54) THERMAL IMAGING SYSTEM CAPABLE OF TRACING SPECIFIC PORTION IN THERMAL IMAGE AND METHOD OF TRACING SPECIFIC PORTION USING THE SAME

(71) Applicants: Jin-Hun Sohn, Daejeon (KR); Jin-Sup Eom, Cheongju-si (KR)

(72) Inventors: Jin-Hun Sohn, Daejeon (KR); Jin-Sup Eom, Cheongju-si (KR)

(73) Assignee: THE INDUSTRY & ACADEMIC COOPERATION IN CHUNGNAM NATIONAL UNIVERSITY (IAC), Daejeon (KR)

(21) Appl. No.: 13/883,715

(22) PCT Filed: Mar. 22, 2012
(86) PCT No.: PCT/KR2012/002064

§ 371 Date: May 6, 2013

(30) Foreign Application Priority Data
Mar. 6, 2012 (KR) 10-2012-23047

(51) Int. Cl. G01J 1/02

(52) U.S. Cl. CPC G01J 1/0242
USPC 348/164

(57) ABSTRACT

The present invention relates to a thermal imaging system capable of tracing a specific portion in a thermal image and a method of tracing a specific portion using thereof. The thermal imaging system includes a thermal imaging camera; an imaging camera installed to be adjacent to the thermal imaging camera; and a position measurement apparatus installed to be adjacent to the thermal imaging camera in order to measure photographing positions of the thermal imaging camera and the imaging camera. Therefore, a specific portion of the subject that is difficult to recognize in the thermal image with naked eyes is recognized by contrasting the specific portion in the thermal image with a corresponding portion in the normal image, and thus a correct temperature can be extracted by tracing the specific portion in the thermal image in real-time.

### TECHNICAL FIELD

The present invention relates to a thermal imaging system, and more specifically, to a thermal imaging system capable of tracing a specific portion in a thermal image and a method of tracing a specific portion using thereof, in which a normal image and a thermal image of a subject are acquired and matched to each other to be overlapped, and thus the specific portion in the thermal image is traced in real-time so as to extract temperature of each position.

### BACKGROUND ART

Generally, a thermal imaging system is an apparatus for photographing heat generated by a subject, which is widely used for industrial purposes such as detecting heat loss of a building, confirming defects of a transmission line, detecting intruders, inspecting and analyzing a printed circuit board, observing meteorological conditions using satellites, extinguishing fire and saving life of firefighters and the like and for medical purposes such as diagnosing neurosurgical symptoms, measuring respiration and pulse rate of a patient and the like. In addition, since the thermal imaging system detects thermal images of a face of a target person and extracts temperature of a specific portion, its utilization is rapidly expanded as far as detecting a lie, measuring normality of respiration or regularity of pulse and the like.

As shown in FIG. 1, such a thermal imaging system 10 of the prior art includes a thermal imaging camera 12 for photographing a subject 11 (e.g., a face, see FIG. 2) and a signal analysis and process device 13 for analyzing an image signal acquired from the thermal imaging camera 12 to be fit for a variety of purposes. Accordingly, the image acquired by the thermal imaging camera 12 is activated on a monitor through the signal analysis and process device 13, and distribution of the heat of the subject 11 is recognized by position through the image activated on the monitor.

However, the thermal image photographed by the thermal imaging camera 12 has a problem in that it is difficult to clearly distinguish a specific portion of the subject 11, particularly, a portion in a face (e.g., an end portion inside an eye), with naked eyes as shown in FIG. 2, and thus it is extremely difficult to trace the specific portion in the thermal image and extract temperature of the specific portion.

### DISCLOSURE OF INVENTION

### Technical Problem

Therefore, the present invention has been made in view of the above problems, and it is an object of the present invention to provide a thermal imaging system capable of tracing a specific portion in a thermal image and a method of tracing a specific portion using thereof, in which a normal image and a thermal image of a subject are acquired, and a specific portion of the subject selected from the normal image is matched to a corresponding portion of the subject in the thermal image so that the normal image is overlapped with the thermal image, and thus the specific portion of the subject in the thermal image is correctly recognized and traced in real-time, and temperature of the specific portion is extracted.

### Technical Solution

To accomplish the above object, according to one aspect of the present invention, there is provided a thermal imaging system capable of tracing a specific portion in a thermal image, the system including: a thermal imaging camera; an imaging camera installed to be adjacent to the thermal imaging camera; and a position measurement apparatus installed to be adjacent to the thermal imaging camera in order to measure photographing positions of the thermal imaging camera and the imaging camera.

Here, the imaging camera and the position measurement apparatus are embedded in the thermal imaging camera.

At this point, the position measurement apparatus includes a distance measurement unit for measuring at least either a photographing distance between the subject and the thermal imaging camera or a photographing distance between the subject and the imaging camera.

In addition, the position measurement apparatus further includes an angle measurement unit for measuring at least either a photographing angle between the subject and the thermal imaging camera or a photographing angle between the subject and the imaging camera.

Meanwhile, the thermal imaging system capable of tracing a specific portion in a thermal image further includes a position correction apparatus for performing a correction so as to overlap a specific portion of a subject in a normal image of the imaging camera with a corresponding portion of a subject in the thermal image of the thermal imaging camera based on a position data acquired by the position measurement apparatus.

At this point, the position correction apparatus corrects at least one position data among a photographing distance and a photographing angle between the subject and the thermal imaging camera and a photographing distance and a photographing angle between the subject and the imaging camera.

Meanwhile, a method of tracing a specific portion in a thermal image using a thermal imaging system according to the present invention includes: a first step S10 of photographing a normal image and a thermal image of a subject respectively using an imaging camera and a thermal imaging camera; a second step S20 of searching for a specific portion of the subject in the normal image; a third step S30 of measuring position data of at least either the thermal imaging camera or the imaging camera with respect to the subject; a fourth step S40 of estimating and searching for a portion in the thermal image corresponding to the specific portion searched from the normal image, and overlapping the normal image with the thermal image through a correction process performed based on the position data so as to match the normal image and the thermal image; and a fifth step S50 of extracting temperature of an interested portion of the subject in the thermal image overlapped with the normal image.

Here, in the second step S20, two or more specific portions are searched for so as to overlap and match the subjects in the normal image and the thermal image.

In addition, the position data measured in the third step S30 is at least either a photographing distance or a photographing angle between the subject and the camera.

In addition, in the fifth step S50, the correction is performed based on at least one position data among the photographing distance and the photographing angle so as to match the subjects in the normal image and the thermal image to each other.

### Advantageous Effects

As described above, according to the present invention, a normal image and a thermal image of a subject is photographed, and the subjects in the normal image and the thermal image are overlapped so as to match each other, so that a specific portion of the subject that is difficult to recognize in the thermal image with naked eyes is recognized by contrasting the specific portion in the thermal image with a corresponding portion in the normal image, and thus it is effective in that a correct temperature can be extracted by tracing the specific portion in the thermal image in real-time. Particularly, the normal image and the thermal image are photographed as a moving image, and the subjects in the normal image and the thermal image are matched to each other after a coordinate of a specific portion of the subject in the normal image is calculated, and thus the specific portion of the subject can be correctly recognized and temperature thereof can be extracted even from a real-time moving image.

In addition, since a thermal imaging camera and an imaging camera are installed to acquire a thermal image and a normal image, a trace apparatus of the present invention can be easily manufactured, and manufacturing and maintenance cost thereof can be reduced.

Furthermore, since a position correction apparatus is installed, distances and angles of the thermal imaging camera and the imaging camera are corrected, and the thermal image and the normal image are exactly matched and overlapped.

### BRIEF DESCRIPTION OF THE DRAWINGS

Features of the present invention will become apparent to those skilled in the art from the following description with reference to the drawings. Understanding that the drawings depict only typical embodiments of the invention and are not therefore to be considered limiting in scope, the invention will be described with additional specificity and detail through the use of the accompanying drawings.

FIG. 1 is a view schematically showing the configuration of a thermal imaging apparatus of the prior art.

FIG. 2 is a view showing a face photographed using the thermal imaging camera of FIG. 1.

FIG. 3 is a view schematically showing the configuration of a thermal imaging system capable of tracing a specific portion in a thermal image according to a preferred embodiment of the present invention.

FIG. 4 is a flowchart illustrating a method of tracing a specific portion in a thermal image using the thermal imaging system of FIG. 3.

### BEST MODE FOR CARRYING OUT THE INVENTION

Preferred embodiments of the present invention will be described in detail below with reference to the accompanying drawings so that those skilled in the art can easily implement the present invention. In addition, if already known functions or specific description of constitution related to the present invention may make the spirit of the present invention unclear, detailed description thereof will be omitted.

<Configuration>

FIG. 3 is a view schematically showing the configuration of a thermal imaging system capable of tracing a specific portion in a thermal image according to a preferred embodiment of the present invention.

First, as shown in FIG. 3, a thermal imaging system 100 capable of tracing a specific portion in a thermal image according to the present invention includes a thermal imaging camera 110, an imaging camera 120, a position measurement apparatus 130 and a position correction apparatus 140.

Here, the thermal imaging camera 110 is a device for photographing a subject 101 and extracting distribution of heat in the subject 101, which is installed to be spaced apart from the subject 101 by a predetermined distance to photograph the subject 101. The imaging camera 120 and the position measurement apparatus 130 are embedded in the thermal imaging camera 110 or installed outside to be close thereto.

In addition, the imaging camera 120 is a device for photographing an external appearance of the subject 101, which is embedded in the thermal imaging camera 110 or installed outside to be close to the thermal imaging camera 110 in order to photograph the subject 101. At this point, it is most preferable to align the position of the lens of the imaging camera 120 with the position of the lens of the thermal imaging camera 110 so that the size and the shape of the subject 101 in a normal image photographed by the imaging camera 120 are identical to those of the subject 101 in a thermal image photographed by the thermal imaging camera 110 so as to avoid separately performing a process of correcting a distance and an angle. Contrarily, when the position of the lens of the imaging camera 120 and the position of the lens of the thermal imaging camera 110 are not aligned with each other, the position measurement apparatus 130 is installed at a position adjacent to the imaging camera 120 and the thermal imaging camera 110 in order to acquire position data which are measurements of different positions of the normal image of the imaging camera 120 and the thermal image of the thermal imaging camera 110. Here, the thermal imaging camera 110 and the imaging camera 120 may acquire a still image or a moving image, may be fixed at a position apart from the subject 101 by a predetermined distance, or may be installed in a mobile means such as a mobile robot so as to continuously move.

In addition, the position measurement apparatus 130 is installed to be embedded in or adjacent to the thermal imaging camera 110 or to be adjacent to the imaging camera 120. The position measurement apparatus 130 includes a distance measurement unit installed to measure a distance between the subject 101 and the imaging camera 120 or the thermal imaging camera 110. For example, when the thermal imaging camera 110 is installed at a predetermined location, the distance measurement unit of the position measurement apparatus 130 is installed to measure a distance between the imaging camera 120 and the subject 101 using infrared rays. The measurement of distance is applied even when the imaging camera 120 is independently installed to be spaced apart from the thermal imaging camera 110 by a predetermined distance, as well as when the imaging camera 120 is installed to be adjacent to or inside the thermal imaging camera 110. In addition, the distance measurement unit is configured to transmit the distance data to the position correction apparatus 140 so that the distance data measured between the imaging camera 120 and the subject 101 may be compared and analyzed with respect to previously input distance data measured between the thermal imaging camera 110 and the subject 101. At this point, a separately installed wired or wireless communication apparatus can be used to transmit the data. In addition, as another example, one or more distance measurement units can be installed so as to simultaneously acquire the distance between the imaging camera 120 and the subject 101 and the distance between the thermal imaging camera 110 and the subject 101. At this point, each of the distance measurement units is installed so as to transmit the distance data to the position correction apparatus 140. Here, a distance between the thermal imaging camera 110 and the imaging camera 120, a difference between absolute sizes of the subjects 101 in the normal image and the thermal image acquired by the thermal imaging camera 110 and the imaging camera 120 and like are previously determined as a constant, respectively. Therefore, a measurement time or a correction time required for correction can be reduced.

In addition, the position measurement apparatus 130 further includes an angle measurement unit installed to measure at least either a photographing angle between the subject 101 and the imaging camera 120 or a photographing angle between the subject 101 and the thermal imaging camera 110. Of course, the imaging camera 120 and the thermal imaging camera 110 photograph two, three, four or more portions to compare the angles of photographing the subject 101. At this point, when the angles of the imaging camera 120 and the thermal imaging camera 110 photographing the subject 101 are different from each other, the angle measurement unit acquires angle data to correct the difference. Here, when the angle of either the thermal imaging camera 110 or the imaging camera 120 is previously set, one angle measurement unit may be installed to measure only the angle of the other camera. For example, when the thermal imaging camera 110 is installed at a photographing angle preset for the subject 101, the angle measurement unit is installed to acquire the photographing angle of the imaging camera 120 embedded in or installed at a position adjacent to the thermal imaging camera 110. Of course, when the photographing angles of the thermal imaging camera 110 and the imaging camera 120 are equal or similar to each other so as not to require a correction, the angle measurement unit may be excluded. In addition, two angle measurement units may be installed so as to simultaneously measure the photographing angles of the thermal imaging camera 110 and the imaging camera 120.

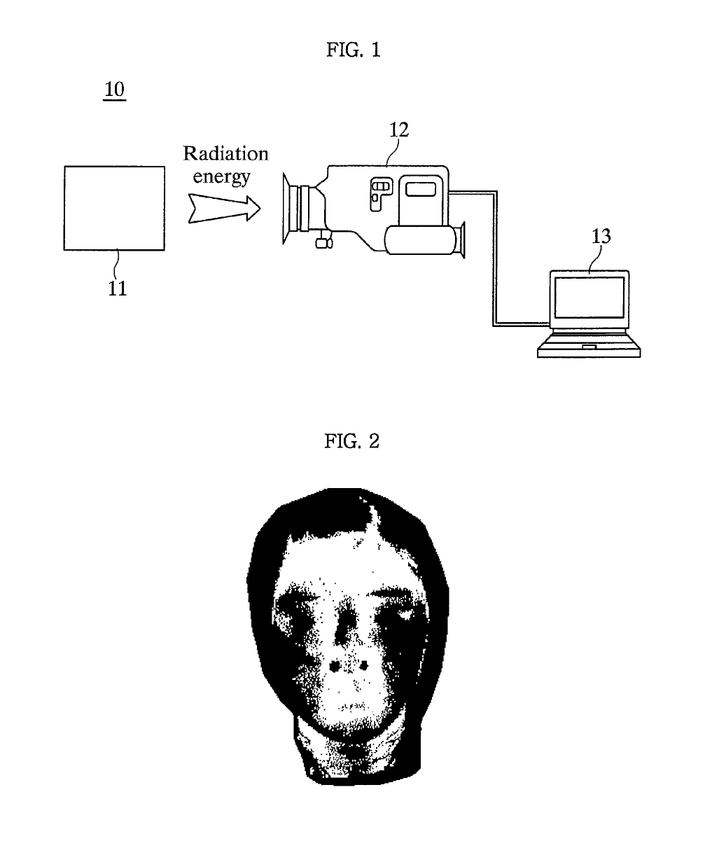

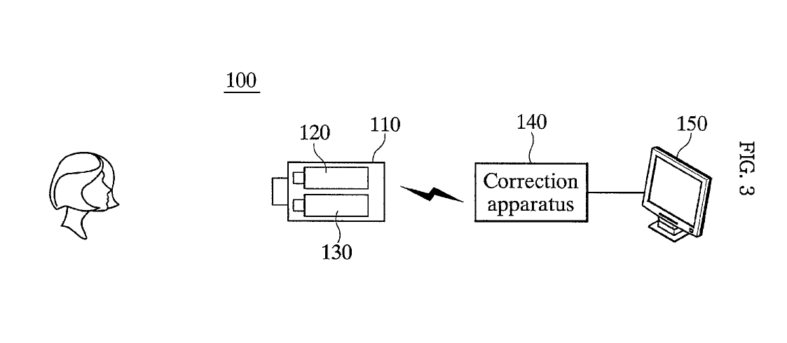

Meanwhile, the position correction apparatus 140 is configured to compare and analyze the position data received from the position measurement apparatus 130, the position data including the photographing distances and photographing angles of the imaging camera 120 and the thermal imaging camera 110 with respect to the subject 101, and performs a correction so that the size and shape of the subject in the normal image may be equal to those of the subject in the thermal image. Here, the position correction apparatus 140 previously stores a phenomenon in which the more the photographing distance between the imaging camera 120 or the thermal imaging camera 110 and the subject 101 is increased, the more a deviation caused by the distance and angle of the subject 101 acquired from the normal image or the thermal image is decreased. Particularly, in order to exactly overlap the normal image of the imaging camera 120 with the thermal image of the thermal imaging camera 110, the position correction apparatus 140 selects a specific portion of the subject 101 from the normal image, calculates a coordinate value of the specific portion, and performs a correction so that the specific portion of the subject 101 in the normal image is positioned to be exactly matched to a corresponding portion of the subject 101 in the thermal image. For example, if the subject 101 is a face, the eyes and nose of the face are selected from the normal image, and coordinates value of the eyes and nose are automatically calculates by a separately provided face recognition program. Then, positions of the eyes and nose are estimated by inputting the coordinate values into the thermal image, and a correction is made to match the positions of the eyes and nose in the normal image to those in the thermal image while inputting the thermal image into the normal image. Of course, it is natural that the correction is performed based on the position data of the position measurement apparatus 130. At this point, the position data includes any one or more of the photographing distance and the photographing angle between the imaging camera 120 and the subject 101 and between the thermal imaging camera 110 and the subject 101. Of course, data other than the photographing distance and the photographing angle may be measured and used to overlap the thermal image with the normal image. The position correction apparatus 140 is installed to receive the position data of the imaging camera 120 and the thermal imaging camera 110. In addition, the position correction apparatus 140 is installed to activate the exactly overlapped normal image and thermal image on a monitor 150 in order to recognize them with naked eyes. At this point, the position correction apparatus 140 operates to match the subjects 101 in the normal image and the thermal image by contrasting a coordinate value of the portion selected from the subject 101 in the normal image with that of the subject 101 in the thermal image while the normal image and the thermal image are overlapped with each other. In addition, the position correction apparatus 140 may be configured to overlap the normal image and the thermal image according to a previously input specific portion and then activate the normal image and the thermal image on the monitor 150. Accordingly, a series of processes of selecting specific portions from the normal image and thermal image and overlapping the selected portions with each other may be accomplished in a manual or automated work, and also a series of processes of selecting an interested portion and extracting a temperature thereof from the thermal image may be accomplished in a manual or automated work. Here, the signal analysis and process device 13 of the prior art (see FIG. 1) may be included in the position correction apparatus 140 or may be separately installed.

<Method>

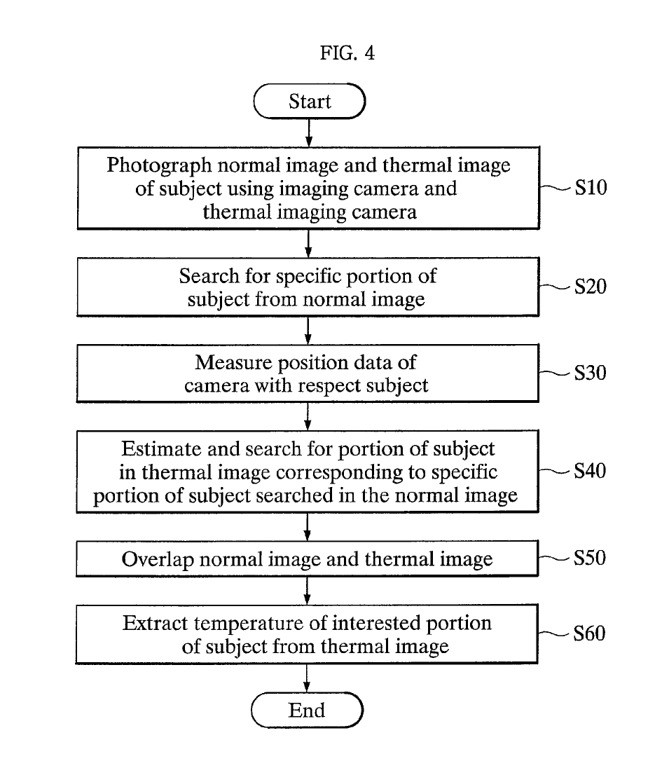

FIG. 4 is a flowchart illustrating a method of tracing a specific portion in a thermal image using the thermal imaging system of FIG. 3.

In a method of tracing a specific portion using a tracing apparatus according to the present invention, first, as shown in FIG. 4, a normal image and a thermal image of a subject 101 are photographed using an imaging camera 120 and a thermal imaging camera 110, respectively S10. At this point, the imaging camera 120 and the thermal imaging camera 110 photograph the subject 101 at different angles with respect to the subject 101 in a fixed or moving state while keeping a predetermined distance and acquire a moving image or a still image as needed. At this point, the imaging camera 120 and the thermal imaging camera 110 may not have the same photographing angle for the same subject 101, and deviation of the photographing angle will be corrected later.

Next, a specific portion of the subject 101 in the normal image is searched for S20. For example, when a face is photographed, positions of the eyes and nose of the face shown in the normal image are searched for, and coordinate values thereof are calculated. Of course, in the case of a subject 101 other than the face, two or more easily recognizable portions of the subject 101 are selected as specific portions so as to easily confirm the portions with naked eyes and calculate coordinate values thereof. At this point, the positions of the eyes and nose are automatically searched for by, for example, a face recognition program, and coordinate values of the corresponding positions are automatically calculated. In addition, it is to easily match the subjects 101 in two overlapped images using the naked eyes or the coordinate values when the normal image and the thermal image are overlapped later with each other through the angles and distances between the searched specific portions of the subject 101. Here, the reason of searching for two or specific portions of the subject 101 is to easily match the subjects 101 in the normal image and the thermal image using the angles and distances between the two or more searched specific portions. That is, if the subjects 101 in the normal image and the thermal image can be matched to each other, only one specific portion of the subject 101 may be selected. That is, a size, a shape and an angle of inclination from the horizontal surface or the like of one specific portion of the subject 101 are precisely measured from the normal image, and then, if the specific portion in the normal image can be matched to a corresponding portion of the subject 101 in the thermal image, only one specific portion may be selected from the subject 101.

Next, position data of at least one camera among the imaging camera 120 and the thermal imaging camera 110 with respect to the subject 101 is measured S30. At this point, the position data is measured for either a photographing distance or a photographing angle. Here, as an example of the photographing distance, when a photographing distance between the subject 101 and the thermal imaging camera 110 is previously determined, a photographing distance between the subject 101 and the imaging camera 120 is measured. Alternatively, when a photographing distance between the subject 101 and the imaging camera 120 is previously determined, a photographing distance between the subject 101 and the thermal imaging camera 110 is measured, or both of the photographing distance between the subject 101 and the imaging camera 120 and the photographing distance between the subject 101 and the thermal imaging camera 110 may be measured. In addition, when photographing angles of the imaging camera 120 and the thermal imaging camera 110 with respect to the subject 101 are different from each other, at least one or more photographing angles of the imaging camera 120 and the thermal imaging camera 110 are measured. The subjects 101 in the normal image and the thermal image are exactly matched later through a correction process performed based on the position data including the photographing distance and the photographing angle. Here, even when the imaging camera 120 and the thermal imaging camera 110 are fixed or moved, the position data with respect to the subject 101 is also measured correctly. Measurement of the photographing distance and the photographing angle is also applied when the imaging camera 120 and the thermal imaging camera 110 are independently installed, as well as when the imaging camera 120 is embedded in the thermal imaging camera 110 or installed to be close thereto.

Next, a portion of the subject 101 in the thermal image corresponding to the specific portion of the subject 101 in the normal image is estimated and searched for S40, and the normal image and the thermal image are overlapped through a correction process performed based on the position data S50. The position data includes the photographing distances and the photographing angles of the imaging camera 120 and the thermal imaging camera 110 with respect to the subject 101. As an example of searching for a specific portion of the subject 101 in the normal image, if the eyes and nose of a face are searched from the normal image, coordinate values of the eyes and nose in the normal image are automatically calculated, and the portions corresponding to the eyes and nose of the face are estimated and searched for by applying the coordinate values to the thermal image. This is an initial process of overlapping the normal image with the thermal image, which is performed to approximately match the faces in the normal image and the thermal image when the thermal image is initially overlapped with the normal image. In addition, as an example of the correction, after the thermal image is overlapped with the normal image so that the positions of the eyes and nose in the normal image is approximately matched to the positions of the eyes and nose in the thermal image based on the coordinate values, the faces in the normal image and the thermal image are exactly matched by applying the position data. At this point, the size or skewed angle of the faces in the normal image and the thermal image are corrected. In addition, either the photographing distance or the photographing angle or both of them may be corrected.

Finally, temperature of an interested portion of the subject 101 is extracted from the thermal image S50. If the subject 101 in the normal image is exactly matched to and overlapped with the subject 101 in the thermal image, the position of a portion of the subject 101 in the thermal image, which is difficult to correctly recognize, may be correctly recognized using the subject 101 in the normal image. Accordingly, a specific portion that is difficult to be distinguished in the thermal image is correctly recognized through the normal image, and temperature of the portion is extracted. For example, after the face in the thermal image is matched to the face in the normal image, even an end portion inside an eye of a face that is difficult to recognize in the thermal image can be correctly recognized through the normal image, and correct temperature of the portion can be extracted.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A thermal imaging system capable of tracing a specific portion in a thermal image, the system comprising:
a thermal imaging camera 110;
an imaging camera 120 installed to be adjacent to the thermal imaging camera 110; and
a position measurement apparatus 130 installed to be adjacent to the thermal imaging camera 110 in order to measure photographing positions of the thermal imaging camera 110 and the imaging camera 120 with respect to a subject 101.

2. The system according to claim 1, wherein the imaging camera 120 and the position measurement apparatus 130 are embedded in the thermal imaging camera 110 or installed to be adjacent and fixed to the thermal imaging camera 110.

3. The system according to claim 1, wherein the position measurement apparatus 130 includes a distance measurement unit for measuring at least either a photographing distance between the subject 101 and the thermal imaging camera 110 or a photographing distance between the subject 101 and the imaging camera 120.

4. The system according to claim 1, wherein the position measurement apparatus 130 further includes an angle measurement unit for measuring at least either a photographing angle between the subject 101 and the thermal imaging camera 110 or a photographing angle between the subject 101 and the imaging camera 120.

5. The system according to claim 1, further comprising a position correction apparatus 140 for performing a correction so as to overlap a specific portion of a subject 101 in a normal image of the imaging camera 120 with a corresponding portion of a subject 101 in the thermal image of the thermal imaging camera 110 based on a position data acquired by the position measurement apparatus 130.

6. The system according to claim 5, wherein the position correction apparatus 140 corrects at least one position data among a photographing distance and a photographing angle between the subject 101 and the thermal imaging camera 110 and a photographing distance and a photographing angle between the subject 101 and the imaging camera 120.

7. A method of tracing a specific portion using the thermal imaging system according to claim 1, the method comprising:
a first step S10 of photographing a normal image and a thermal image of a subject 101 respectively using the imaging camera 120 and the thermal imaging camera 110;
a second step S20 of searching for a specific portion of the subject 101 in the normal image;
a third step S30 of measuring position data of at least either the thermal imaging camera 110 or the imaging camera 120 with respect to the subject 101;
a fourth step S40 of estimating and searching for a portion in the thermal image corresponding to the specific portion searched from the normal image, and overlapping the normal image with the thermal image through a correction process performed based on the position data so as to match the normal image and the thermal image; and
a fifth step S50 of extracting temperature of an interested portion of the subject 101 in the thermal image overlapped with the normal image.

8. The method according to claim 7, wherein in the second step S20, two or more specific portions are searched for so as to overlap and match the subjects 101 in the normal image and the thermal image.

9. The method according to claim 7, wherein the position data measured in the third step S30 is at least either a photographing distance or a photographing angle between the subject and the camera.

10. The method according to claim 9, wherein in the fifth step S50, the correction is performed based on at least one position data among the photographing distance and the photographing angle so as to match the subjects 101 in the normal image and the thermal image to each other.

11. The system according to claim 3, wherein the position measurement apparatus 130 further includes an angle measurement unit for measuring at least either a photographing angle between the subject 101 and the thermal imaging camera 110 or a photographing angle between the subject 101 and the imaging camera 120.

12. A method of tracing a specific portion using the thermal imaging system according to 5, the method comprising:
a first step S10 of photographing a normal image and a thermal image of a subject 101 respectively using the imaging camera 120 and the thermal imaging camera 110;
a second step S20 of searching for a specific portion of the subject 101 in the normal image;
a third step S30 of measuring position data of at least either the thermal imaging camera 110 or the imaging camera 120 with respect to the subject 101;
a fourth step S40 of estimating and searching for a portion in the thermal image corresponding to the specific portion searched from the normal image, and overlapping the normal image with the thermal image through a correction process performed based on the position data so as to match the normal image and the thermal image; and
a fifth step S50 of extracting temperature of an interested portion of the subject 101 in the thermal image overlapped with the normal image.
